(19) United States
(12) Patent Application Publication
(10) Pub. No.: US 2007/0003726 A1
(43) Pub. Date: Jan. 4, 2007

(54) Adjustable width edge protector with self adhesive and release liner

(76) Inventor: Robert W. Swannell, Neenah, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/205,555

(22) Filed: Aug. 17, 2005

Related U.S. Application Data
(63) Continuation-in-part of application No. 11/150,674, filed on Jun. 10, 2005.

(51) Int. Cl. B32B 33/00

(52) U.S. Cl. 428/40.1; 428/194; 428/121

(57) ABSTRACT

An elongated U-shaped edge protector for protecting an edge of an article. The U-shaped edge protector is formed from a pair of V-shaped edge protectors joined together to define an internal receiving cavity. The size of the receiving cavity can be adjusted prior to attachment of the inner edge protector to the outer edge protector. At least one of the inner and outer edge protectors includes an adhesive strip applied to only one leg of the main body such that the outer edge protector can be adhered to the inner edge protector. The pressure sensitive adhesive includes a release liner that protects the adhesive prior to attachment of the pair of edge. protectors to create the U-shaped edge protector.

### CROSS REFERENCE TO RELATED APPLICATION

The present invention is a continuation-in-part application of U.S. patent application Ser. No. 11/150,674, filed Jun. 10, 2005.

### BACKGROUND OF THE INVENTION

The present invention generally relates to elongated, U-shaped edge protector for protecting an edge or comer of an item being shipped or transported. More specifically, the present invention relates to a pair of elongated, V-shaped edge protectors at least one of which includes an adhesive strip formed along one leg of the edge protector to permit attachment of the edge protectors to each other to form the U-shaped edge protector.

Packages, articles, products, palletized loads and the like are often subject to damage during shipping or transit. The traditional method of shipping a product, such as a large appliance, involves packaging the product within a cardboard box having cardboard inserts for positioning and holding the product within the box. After each product is packaged within a box, multiple boxes are assembled into an orderly stack onto a pallet or shipping crate. Once the products are assembled onto the pallet, the stack of products are typically wrapped in a heat shrinkable plastic sheet to maintain the integrity of the assembled stack.

During shipment and storage, the comer edges of each box may become damaged. Thus, before the assembled stack is wrapped with the heat shrink plastic material, edge protectors are often used along the outside corners of the assembled stack. Edge or comer protectors are typically formed from one or more pieces of paperboard, cardboard and/or corrugated cardboard folded into a rigid V-shape member having a pair of transversely oriented leg members joined at a generally curved apex.

Although the edge protectors can be manually held in place as the heat shrinkable plastic sheet is wrapped around the assembled stack, it is desirable to provide an edge protector that is self-adhering to facilitate the packaging process. Although a self-adhering edge protector is desirable, the edge protectors must also be stackable for storage prior to use.

Presently, edge protectors are available that include an adhesive material positioned on both legs of the edge protector. When the edge protector is to be used, both legs of the edge protector are attached to the assembled stack of products.

In addition to edge protectors that are used to protect the corners of an article being shipped, U-shaped edge protectors currently exist that are used to protect an edge of an article, such as a window or table top. Currently available U-shaped edge protectors are either integrally formed as a U-shaped member or are formed from two V-shaped edge protectors joined to each other by some type of mechanical interconnection, such as rivets. The U-shaped edge protectors typically have a fixed width and cannot be adjusted once the attachment mechanism, such as the rivets, have been installed to create the U-shaped member.

When the pre-assembled U-shaped edge protectors are created by the manufacturer, the U-shaped edge protectors are stacked onto pallets for shipment. Since the U-shaped edge protectors include opposing side walls, the edge protectors cannot be stacked in a efficient, space saving orientation. Thus, the number of U-shaped edge protectors that can be shipped on a pallet is significantly less than the number of V-shaped edge protectors that can be stacked in the same space.

Therefore, it is desirable to provide an edge protector that can be stored and stacked and includes an adhesive strip along one leg of the edge protector. It is desirable to provide such a V-shaped edge protector such that the edge protector can be combined with another similar edge protector to create a U-shaped edge protector.

Therefore, it is desirable to provide an edge protector that can be stored and stacked and includes an adhesive strip along only one leg of the edge protector for attaching the edge protector to an article. It is desirable to provide such an edge protector that increases the ease of use while providing adequate strength and product protection.

### SUMMARY OF THE INVENTION

The present invention is an edge protector for protecting an edge or comer of an article. The edge protector includes an adhesive strip such that the edge protector can be self-supported along the article being protected.

The edge protector includes a main body having a generally right angle cross-section that is defined by a first leg and a second leg joined to each other along an apex. Generally, the apex defines a right angle between the first and second legs of the main body. Each of the first and second legs includes both an inside face surface and an outside face surface. The main body extends from a first end to a second end.

A pressure-sensitive adhesive strip is positioned along only one of the first and second legs of the main body. The adhesive strip has a width defined by a first edge and a second edge. The pressure-sensitive adhesive strip may be applied to either the outer face surface or the inner face surface of either the first or second leg of the main body. The pressure-sensitive adhesive strip allows the edge protector to be self-supported along an edge or comer of the article being protected.

The edge protector includes a release liner that is removably attached to the adhesive strip to protect the adhesive strip prior to application of the edge protector to the product being protected. The release liner has a width that is greater than or equal to the width of the pressure-sensitive adhesive strip such that the release liner completely covers the pressure-sensitive adhesive strip prior to removal of the release liner from the pressure-sensitive adhesive strip. In one embodiment of the invention, the release liner extends past the adhesive strip to define a grasping tab. The grasping tab can be used by a user to grasp the release liner and remove the release liner from the pressure-sensitive adhesive strip before application of the edge protector to the product being protected.

The adhesive strip can be applied to either the inner face surface or the outer face surface of either leg of the main body. The use of the adhesive strip along the inner face surface of the body allows the edge protector to be applied to an exterior comer of a product, while use of the adhesive strip along the outer face surface of the main body allows the edge protector to be applied to an inner comer of a product package.

In one embodiment of the invention, the main body of the edge protector is formed from a plurality of layers of paperboard plies each laminated together. However, it is contemplated that the edge protector could also be formed from other materials, such as plastic.

In addition to utilizing the edge protectors to protect a comer of a box or stack of boxes, it is contemplated that a pair of the V-shaped edge protectors can be combined to create a U-shaped edge protector. U-shaped edge protectors are particularly desirable for protecting the outer edge of a narrow article, such as a table or window.

The U-shaped edge protector is created by overlapping the first leg of an inner edge protector and the first leg of an outer edge protector. When the inner and outer edge protectors are combined, the U-shaped edge protector defines a receiving cavity having a width extending between the respective second legs of the inner and outer edge protectors. The width of the receiving cavity is determined by the amount of overlap between the first legs of the inner and outer edge protectors. Thus, the width of the receiving cavity of the U-shaped edge protector can be selectively adjusted by the user prior to attachment of the U-shaped edge protector to the article being protected.

During creation of the U-shaped edge protector, the release liner is removed from the adhesive strip formed on the inner face surface of the first leg of the outer protector. Once the release liner is removed, the inner edge protector is brought into contact with the exposed adhesive strip. Preferably, the position of the inner edge protector relative to the outer edge protector is selected to define the desired width for the receiving cavity. Once the inner edge protector is properly positioned, the inner and outer edge protectors are pressed together such that the adhesive strip on the outer edge protector adheres to the inner edge protector to create the U-shaped edge protector.

### BRIEF DESCRIPTION OF THE DRAWINGS

The drawings illustrate the best mode presently contemplated from carrying out the invention in drawings.

FIG. 1 is a perspective view of an assembled stack of articles including a packaging system utilizing the edge protector of the present invention;

FIG. 2 is a front perspective view of the edge protector with the release liner being partially removed;

FIG. 3 is a section view taken along line 3-3 of FIG. 2;

FIG. 4 is a magnified view of the adhesive strip and release liner taken along line 4-4 of FIG. 3;

FIG. 5 is a perspective view illustrating the use of the edge protector along an inside corner of a product package;

FIG. 6 is a perspective view of the edge protector including the adhesive strip and release liner along an outer face surface of one of the product legs;

FIG. 7 is a perspective view of a pair of V-shaped edge protectors adhesively attached to each other and utilized to protect the edge of an article;

FIG. 8 is a section view taken along 8-8 of FIG. 7 showing the interconnection of the pair of edge protectors;

FIG. 9 is a section view similar to FIG. 8 illustrating the adjustable width of the U-shaped edge protector;

FIG. 10 is a exploded perspective view illustrating the removal of the release liner from one of the edge protectors prior to attachment to another edge protector; and

FIG. 11 is a perspective view illustrating the formation of a U-shaped edge protector from the pair of V-shaped edge protectors.

### DETAILED DESCRIPTION OF THE INVENTION

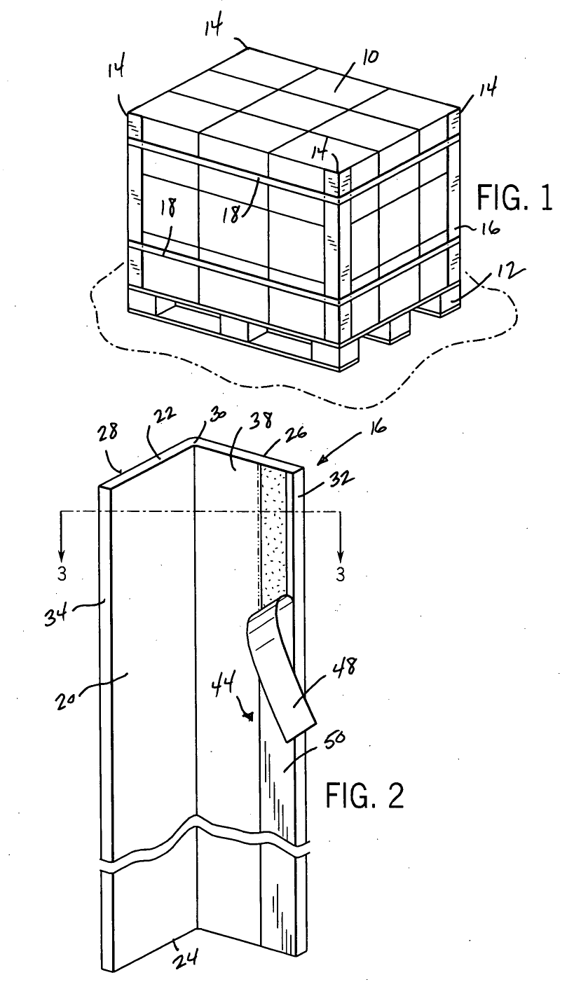

Referring first to FIG. 1, a plurality of individual articles 10 are shown stacked on a pallet 12 for storing or shipment. In the embodiment shown in FIG. 1, the articles 10 are each represented by cardboard boxes, each of which may include a product being shipped by a manufacturer or retailer. The stack of articles define outer comers 14 that are exposed and can be damaged during storage and shipment. To protect the comer articles, a packaging system including multiple edge protectors 16 and retaining straps 18 can be used. The edge protectors 16 are positioned along the outer comers 14 of the assembled stack of articles 10 and protect the comers of each article 10 from damage during shipment and from the pressure exerted by the retaining straps 18. The retaining straps 18 could be replaced by a shrink wrap plastic material.

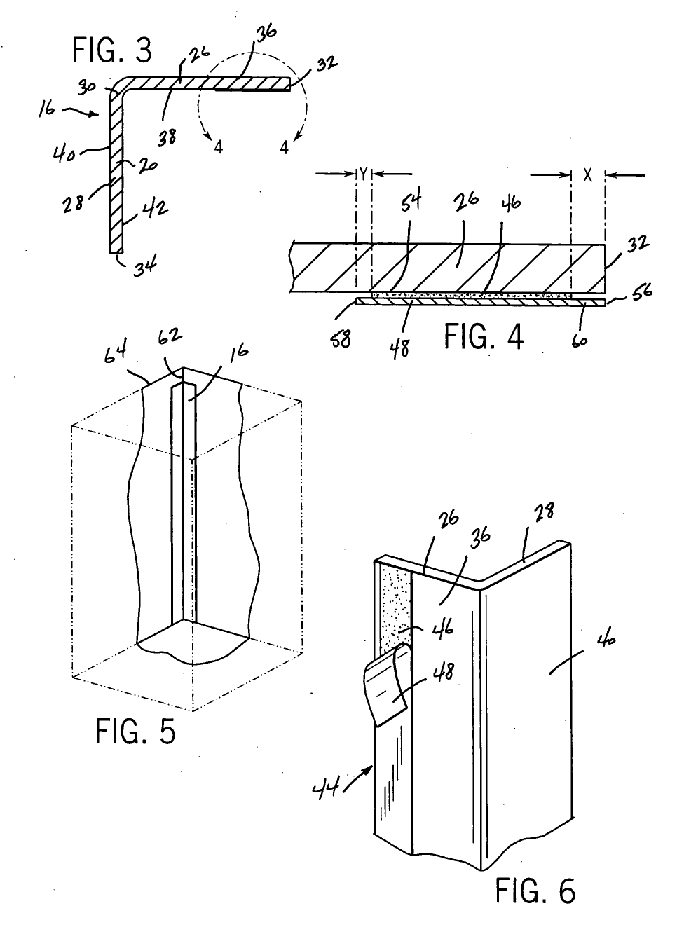

Referring to FIGS. 2 and 3, the edge protector 16 includes a main body 20 extending between a first end 22 and a second end 24. The main body 20 has a generally 90° right angle cross-section formed by a first leg 28 and a second leg 26 joined to each other along an apex 30. The first leg 26 extends from the apex 30 to an outer edge 32 while the second leg 28 extends from the apex 30 to outer edge 34.

The main body 24, including the first and second legs 26, 28 is preferably formed from a plurality of paperboard plies laminated together and formed into the generally V-shaped right angle configuration shown in FIGS. 2 and 3. The manufacture and creation of a right angle edge protector is well known in the industry.

As to be understood in FIG. 3, the angle between the first leg 26 and the second leg 28 is preferably close to 90°. However, due to the manufacturing process used to form the main body 20, the angle defined by the apex 30 may be slightly greater than or slightly less than the desired 90°.

As can be seen in FIG. 3, the first leg 26 includes an outer face surface 36 and an inner face surface 38. Likewise, the second leg 28 also includes an outer face surface 40 and an inner face surface 42. The outer face surfaces 36, 40 of the edge protector 16 can be formed from either a strip of paperboard material or can include a clay-coated paper label. The use of a paper label along the outer face surfaces 36, 40 allows graphics to be printed along the outer face surfaces 36, 38 as is well known.

Referring back to FIG. 2, the first leg 26 includes a length of adhesive tape 44 attached to the inner face surface 38. The adhesive tape 44 includes a pressure-sensitive adhesive strip 46 and a removable release liner 48. The adhesive tape 44 is typically supplied on a continuous roll and is applied to the inner face surface 38 during the manufacture of the edge protector 16. The continuous roll of the adhesive tape 44 is created such that the adhesive strip 46 is applied to the top surface 50 of the release liner 48 such that the adhesive tape 44 can be unwound and applied to the edge protector 16.

As illustrated in FIG. 2, once the adhesive tape 44 has been applied to the inner face surface 38, the release liner 48 can be removed to expose the adhesive strip 46. The adhesive strip 46 allows the edge protector 16 to be attached to one of the outer corners 14 of the assembled stack of articles 10, as illustrated in FIG. 1. Since the edge protector 16 is held in place along the assembled stack of articles, the four edge protectors 16 shown in FIG. 1 can be applied to each of the comers 14 and do not need to be held in place while the retaining straps 18 or plastic wrapping material is applied to the entire stack of articles on the pallet 12.

As can be understood in FIGS. 2 and 3, the adhesive tape 44 is applied only to the first leg 26 of the edge protector 16 and is not applied to the second leg 28. The use of the adhesive tape 44 along only one leg of the edge protector 16 is sufficient to hold the edge protector 16 along the assembled stack of articles. Additionally, since the angle between the first leg 26 and the second leg 28 defined by the apex 30 may be greater than or less than an optimal 90°, the use of the adhesive tape 44 along only one of the two legs 26, 28 aids in applying the edge protector 16 to the comer of the assembled stack shown in FIG. 1. If the adhesive tape 44 were applied to both of the legs 26, 28 and the apex 30 created an angle slightly greater than 90°, the two sections of adhesive tape would not be able to be attached to each side of the comer 14 of the assembled stack of articles. Therefore, the use of only a single adhesive strip 46 along only one of the first and second legs 26, 28 allows the edge protector 16 to be adhered to the comer of an assembled stack of articles and decreases the overall cost of producing the edge protector 16.

Referring now to FIG. 4, the adhesive strip 46 includes a width defined by a first edge 52 and a second edge 54. The first edge 52 is positioned generally adjacent to the outer edge 32 of the first leg 26.

The adhesive strip 46 is covered by the release liner 48 as illustrated in FIG. 4. The release liner 48 has a width extending between a first edge 56 and a second edge 58. As illustrated in FIG. 4, the width of the release liner 48 is greater than the width of the adhesive strip 46 such that the first and second edges 56, 58 of the release liner extend past the first and second edges 52, 54 of the adhesive strip 46.

In the embodiment shown in FIG. 4, the first edge 56 of the release liner 48 extends past the first edge 52 of the adhesive strip by a distance X, while the second edge 58 of the release liner 48 extends past the second edge 54 of the adhesive strip by a second distance Y. In the embodiment of the invention illustrated, the distance X is greater than the distance Y. In one contemplated embodiment of the invention, the distance X is ¼″ and the distance Y is ⅛″. The release liner 48 defines a grasping tab 60 having a width of X. The edge of the grasping tab 60, which is defined by the first edge 56, is positioned generally in alignment with the outer edge 32 of the first leg 26. The grasping tab 60 provides an increased area of the release liner 48 that is not attached to the adhesive strip, which aids in permitting the removal of the release liner 48. Although the distances X and Y are shown and described as being different, it is contemplated that the release liner 48 could extend an equal distance from each of the edges 52, 54 of the adhesive strip 46.

The adhesive strip 46 of the adhesive tape 44 can be either a permanent adhesive or a releasable adhesive. If the edge protector 16 is to be applied to a sturdy article and a more aggressive adhesive is needed, the adhesive strip 46 can be a permanent adhesive. However, if the edge protector 16 is to be applied to an article that can be easily damaged, a releasable adhesive can be used so as to not damage the article when the edge protector 16 is removed. In each case, the adhesive strip 46 must be strong enough to hold the edge protector 16 in place prior to application of the retaining straps 18.

In the embodiment of the invention illustrated in FIG. 2, the adhesive tape 44 extends from the first end 22 to the second end 24 of the main body 20. However, it is contemplated that the length of the adhesive tape 44 could be less than the entire length from the first end 22 to the second end 24. The length of the adhesive tape 44 must be sufficient to support the weight of the edge protector 16. Thus, the strength of the adhesive used in the adhesive strip 46 and the length of the main body 20 dictate the length of the adhesive tape 44 required.

Referring now to FIGS. 5 and 6, thereshown is an alternate embodiment of the edge protector 16. In the edge protector 16 shown in FIG. 6, the adhesive tape 44 is applied to the outer surface 36 of the first leg 26. The adhesive tape 44 includes both the release liner 48 and the adhesive strip 46. However, in the embodiment shown in FIGS. 5 and 6, the adhesive tape 44 is applied to the outer surface 36 of the first leg 26 rather than the inner surface 38 as shown in FIG. 2.

As illustrated in FIG. 5, the edge protector 16 can be applied to an inside corner 62 of a storage container 64 by utilizing the adhesive tape 44 on the outer surface 36. The use of the edge protector 16 along the inside corner 62 strengthens the storage container 64 while providing additional protection from the product.

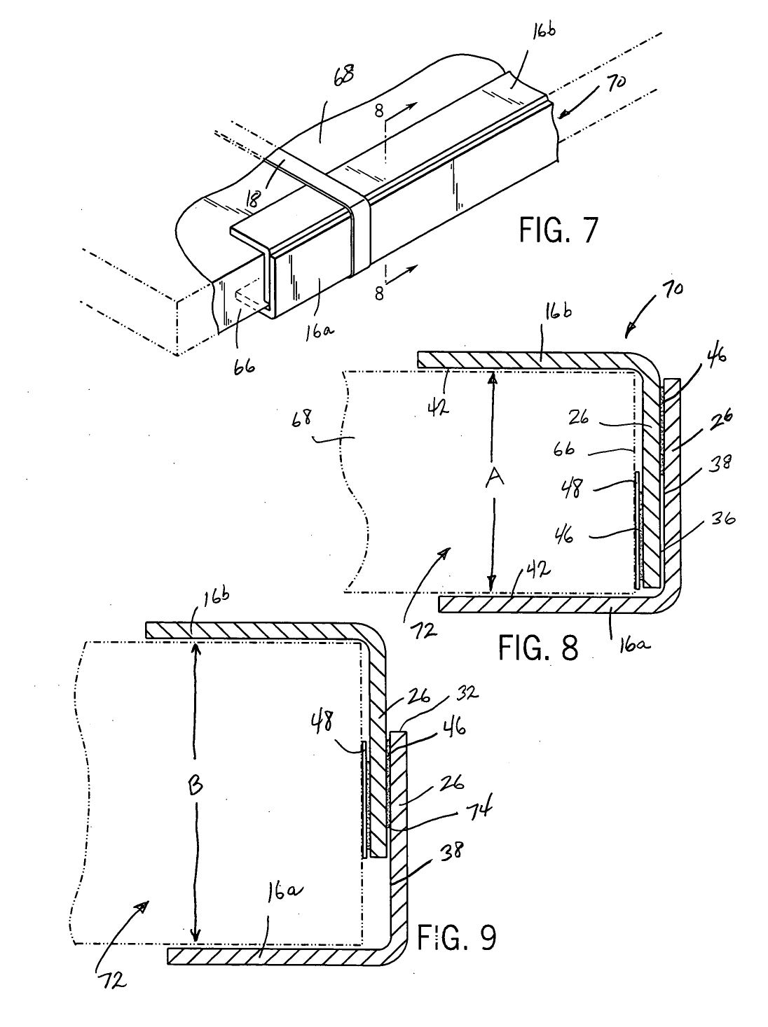

In addition to utilizing the edge protectors 16 to protect the corner of a box or article, a pair of the edge protectors 16 can be combined to protect the edge 66 of a generally flat article 68, such as a door, window or similar article. As illustrated in FIG. 7, the pair of edge protectors 16a, 16b are joined to each other and overlap to create a U-shaped edge protector 70. The U-shaped edge protector 70 is held in place on the article 68 by a retaining strap 18.

As illustrated in FIG. 8, the U-shaped edge protector 70 is formed from the pair of edge protectors 16a, 16b joined together. Specifically, the adhesive strip 46 contained on the inner face surface 38 of the first leg 26 adheres the outer edge protector 16a to the outer face surface 36 of the inner edge protector 16b. As shown in FIG. 8, the release liner 48 remains attached to the adhesive strip 46 contained on the first leg 26 of the inner corner protector 16b and contacts the edge 66 of the article 68. It is contemplated that the release liner 48 could be removed such that the adhesive strip 46 would aid in securing the inner edge protector 16b to the article 68. When the release liner 48 is removed, it is contemplated that the retaining straps could be eliminated, since the U-shaped edge protector 70 would be self-adhered to the article 68.

As illustrated in FIG. 8, the U-shaped edge protector 70 defines a receiving cavity 72 having a width A defined by the distance between the inner face surface 42 of the outer edge protector 16a and the inner face surface 42 of the inner edge protector 16b. The width A of the retaining cavity 72 is determined by the amount of overlap between the first legs 26 of the inner and outer comer protectors 16a, 16b.

As can be understood in FIG. 9, the width of the receiving cavity 72 can be increased by adjusting the amount of overlap between the first legs 26 of the inner edge protector 16b and the outer edge protector 16a. In the embodiment illustrated in FIG. 9, the width of the receiving cavity 72 is increased to the width B, which is significantly larger than the width A of the receiving cavity 72 shown in FIG. 8. As can be understood in FIG. 9, the maximum width of the receiving cavity 72 is determined by the position of the adhesive strip 46 on the inner face surface 38 of the first leg of the outer edge protector 16a. If the adhesive strip 46 is positioned near the outermost edge 32, the possible width of the receiving channel 72 is maximized. Thus, the maximum width for the receiving cavity is approximately the combined length of the pair of first legs 26 minus the distance from the outer edge 32 to the inner edge 74 of the adhesive strip and minus the contact area required on the first leg 26 of the inner edge protector 16b.

FIG. 10 illustrates the U-shaped edge protector 70 prior to assembly. Initially, the inner edge protector 16b and the outer edge protector 16a are aligned to create the desired distance between the second legs 28. Once the desired width of the receiving cavity between the second legs 26 is created, the release liner 48 is removed from the adhesive strip 46 attached to the inner face surface 38 of the first leg 26 of the outer edge protector 16a.

Once the release liner 48 has been completely removed, the outer face surface 38 of the inner edge protector 16b is brought into contact with the adhesive strip 46. Preferably, the adhesive strip 46 is formed from an adhesive material strong enough to retain the inner edge protector 16b in contact with the outer edge protector 16a to form the completed U-shaped edge protector 70 shown in FIG. 2. As discussed previously, if the width of the receiving cavity 72 needs to be larger or smaller, the amount of overlap between the first legs 26 of the inner and outer edge protector 16a, 16b can be adjusted.

Since the edge protectors 16a and 16b are shipped to the assembly location separate and with release liners attached to the adhesive strip, the U-shaped edge protector 70 can be assembled on site prior to installation. It is contemplated that the user could initially fit the pair of edge protectors 16a, 16b into the U-shaped edge protector 70 and determine the desired width required prior to the removal of the release liner. Once the correct sizing of the U-shaped edge protector 70 is determined, the release liner 48 can be removed and the pair of edge protectors 16a, 16b can be assembled into the U-shaped edge protector 70 shown.

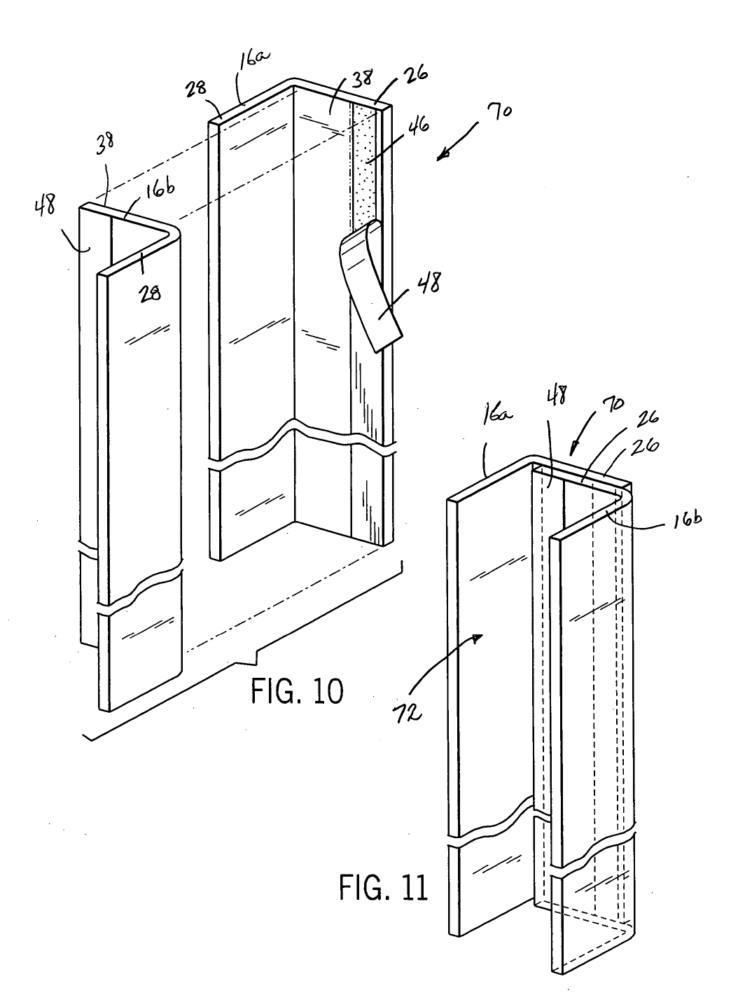

In addition to the embodiment shown in FIGS. 7-11, it is also contemplated that a pair of edge protectors similar to the alternate embodiment shown in FIG. 6 could be combined to create the U-shaped edge protector. In the embodiment of the invention shown in FIG. 6, the edge protector includes the adhesive tape 44 applied to the outer surface 36 of the first leg 26. When a pair of edge protectors including the adhesive tape applied to the outer surface 36 are aligned as shown in FIGS. 8-9, the adhesive strip 46 formed on the outer surface 36 of the inner edge protector 16b would contact the inner surface 38 of the outer edge protector 16a. However, unlike the embodiment shown in FIGS. 8-9, an adhesive strip would be present on the outer surface 36 of the outer edge protector 16a. In such an embodiment, the U-shaped edge protector 70 could then be applied to an inside corner as desired.

Although both the outer edge protector 16a and inner edge protector 16b are shown having the adhesive strip 46 and release liner 48, it is contemplated that the inner edge protector 16b could be created without the adhesive strip and release liner. Although the elimination of the adhesive strip and release liner from the inner edge protection 16b would result in decreased material costs, the customer would then be required to maintain separate inventories of the inner and outer edge protectors 16a, 16b. Therefore, it is contemplated that the decrease in material cost gained by eliminating the release liner and adhesive strip on the inner edge protector 16b may be offset by the cost required to inventory two separate components.

Various alternatives and embodiments are contemplated as being within the scope of the following claims particularly pointing out and distinctly claiming the subject matter regarded as the invention.

What is claimed is:

1. A method of forming a U-shaped edge protector for protecting an edge of an article, the method comprising the steps of:
providing a V-shaped outer edge protector having a generally right angle cross section defined by a first leg and a second leg joined at an apex;
providing a V-shaped inner edge protector having a generally right angle cross section defined by a first leg and a second leg joined at an apex, wherein the first leg of at least one of the outer edge protector and the inner edge protector includes a pressure-sensitive adhesive strip positioned along the first leg and a release liner removably adhered to the adhesive strip;
removing the release liner from the adhesive strip; and
moving the first leg of the inner edge protector into contact with the first leg of the outer edge protector such that the inner edge protector is adhered to the outer edge protector to define the U-shaped edge protector.

2. The method of claim 1 further comprising the step of adjusting the distance between the second leg of the inner edge protector and the second leg of the outer edge protector to define a receiving cavity therebetween prior to adhering the inner edge protector to the outer edge protector.

3. The method of claim 1 wherein the inner edge protector includes a pressure sensitive adhesive strip positioned along only the first leg and a release liner removably adhered to the adhesive strip.

4. The method of claim 1 wherein the adhesive strip is positioned along an inner face of the first leg of the outer edge protector and is adhered to an outer face of the first leg of the inner edge protector.

5. The method of claim 1 wherein the adhesive strip is positioned along an outer face of the first leg of the inner edge protector and is adhered to an inner face of the first leg of the outer edge protector.

6. The method of claim 1 wherein both the inner edge protector and the outer edge protector are formed from a plurality of layers of paperboard plies.

7. The edge protector of claim 1 wherein the adhesive strip includes a permanent adhesive.

8. The edge protector of claim 1 wherein the adhesive strip includes a releasable adhesive.

9. The method of claim 1 further comprising the step of:
overlapping the first leg of the inner edge protector and the first leg of the outer edge protector;
adjusting the amount of overlap between the first leg of the inner edge protector and the first leg of the outer edge protector to adjust the distance between the second leg of the inner edge protector and the second leg of the outer edge protector prior to adhering the inner edge protector to the outer edge protector.

10. The method of claim 9 wherein the inner edge protector includes a pressure sensitive adhesive positioned along an inner face of the first leg and a release liner removably adhered to the adhesive strip, further comprising the steps of:
removing the release liner from the adhesive strip positioned along the inner edge protector; and
moving the U-shaped edge protector into contact with the edge of the article such that the adhesive strip positioned along the inner edge protector adheres the U-shaped edge protector to the article.

11. An elongated U-shaped edge protector for protecting an edge of an article, the edge protector comprising:
a V-shaped outer edge protector having a generally right angle cross section defined by a first leg and a second leg joined at an apex, the outer edge protector having a pressure sensitive adhesive strip positioned along only the first leg; and
a V-shaped inner edge protector having a generally right angle cross section defined by a first leg and a second leg joined at an apex,
wherein the first leg of the inner edge protector being in contact with the pressure sensitive adhesive strip of the outer edge protector such that the inner edge protector is adhered to the outer edge protector to define the U-shaped edge protector.

12. The U-shaped edge protector of claim 11 wherein the inner edge protector includes a pressure sensitive adhesive strip positioned along only the first leg and a release liner removably adhered to the adhesive strip.

13. The edge protector of claim 12 wherein the U-shaped edge protector includes a receiving cavity defined between the second leg of the inner edge protector and the second leg of the outer edge protector.

14. The U-shaped edge protector of claim 12 wherein the first leg of the outer edge protector overlaps the first leg of the inner edge protector such that the pressure sensitive adhesive strip positioned along an inner face surface of the first leg contacts an outer face surface of the first leg of the inner edge protector.

15. The U-shaped edge protector of claim 14 wherein the width of the receiving cavity is defined by the amount of overlap between the first legs of the inner edge protector and the outer edge protector.

16. An elongated U-shaped edge protector for protecting an edge of an article, the edge protector comprising:
a V-shaped outer edge protector having a generally right angle cross- section defined by a first leg and a second leg joined at an apex; and
a V-shaped inner edge protector having a generally right angle cross- section defined by a first leg and a second leg joined at an apex, the inner edge protector having a pressure-sensitive adhesive strip positioned along only the first leg,
wherein the first leg of the outer edge protector is in contact with the pressure-sensitive adhesive of the inner edge protector such that the outer edge protector is adhered to the inner edge protector to define the U-shaped edge protector.

17. The U-shaped edge protector of claim 16 wherein the U-shaped edge protector includes a receiving cavity defined between the second leg of the inner edge protector and the second leg of the outer edge protector.

18. The U-shaped edge protector of claim 16 wherein the first leg of the outer edge protector overlaps the first leg of the inner edge protector such that the pressure-sensitive adhesive strip positioned along the outer face surface of the first leg contacts an inner face surface of the first leg of the outer edge protector.

19. The U-shaped edge protector of claim 18 wherein the width of the receiving cavity is defined by the amount of overlap between the first legs of the inner edge protector and the outer edge protector.
